(19) United States
(12) Patent Application Publication
(10) Pub. No.: US 2006/0139249 A1
(43) Pub. Date: Jun. 29, 2006

(54) Electron emission display and a method of driving the electron emission display

(76) Inventor: Mun-Seok Kang, Suwon-si (KR)

Correspondence Address: Robert E. Bushnell, Suite 300, 1522 K Street, N.W., Washington, DC, 20005-1202, US

(21) Appl. No.: 11/305,137

(22) Filed: Dec. 19, 2005

(30) Foreign Application Priority Data
Dec. 23, 2004 (KR) 10-2004-0111099

(51) Int. Cl. G09G 3/22

(52) U.S. Cl. 345/75.2

(57) ABSTRACT

An electron emission display includes: cathode electrode lines electrically connected to electron emission sources; gate electrode lines including openings corresponding to the electron emission sources, the openings being arranged at intersections of the gate electrode lines and the cathode electrode lines; phosphor cells arranged to correspond to the openings of the gate electrode lines; and a positive plate adapted to receive a voltage and to move electrons emitted from the electron emission sources to the phosphor cells in accordance with the received voltage. Scanning pulses, having gradually rising voltages, are sequentially supplied to the gate electrode lines in a unit frame, such that reference voltages of the gate electrode lines gradually rise in proportion to relative distances between the gate electrode lines and driving terminals of the cathode electrode lines.

### CLAIM OF PRIORITY

This application makes reference to, incorporates the same herein, and claims all benefits accruing under 35 U.S.C. §119 from an application for ELECTRON EMISSION DISPLAY APPARATUS WHEREIN REFERENCE ELECTRICAL POTENTIAL OF SCANNING ELECTRODE LINES VARIES earlier filled in the Korean Intellectual Property Office on 23 Dec. 2004 and there duly assigned Serial No. 10-2004-0111099.

### BACKGROUND OF THE INVENTION

1. Field of the Invention

The present invention relates to an electron emission display and a method of driving the electron emission display, and, more particularly, to an electron emission display including cathode electrode lines, gate electrode lines, phosphor cells, and a positive plate, and a method of driving the electron emission display.

2. Description of the Related Art

An electron emission display is discussed in U.S. Patent Publication No. 2003/0122118, entitled “FED Driving Method”, published on Jul. 3, 2003. The electron emission display includes cathode electrode lines, gate electrode lines, phosphor cells, and a positive plate. The cathode electrode lines are electrically connected to electrode emission sources. In the gate electrode lines, openings corresponding to the electrode emission sources are formed at portions where the gate electrode lines intersect the cathode electrode lines. The phosphor cells are formed to correspond to the openings of the gate electrode lines. A voltage is supplied to the positive plate to move electrons emitted from the electron emission sources to the phosphor cells. The gate electrode lines are used as scanning electrode lines and the cathode electrode lines are used as data electrode lines.

In such an electron emission display, the cathode electrode lines used as data electrode lines have an internal resistance. Accordingly, pixels disposed far from driving terminals for driving the cathode electrode lines used as data electrode lines have lowered brightness, which deteriorates image reproducibility.

### SUMMARY OF THE INVENTION

The present invention provides an electron emission display which enhances image reproducibility by efficiently compensating for brightness deviations due to the internal resistance of cathode electrode lines, and a method of driving the electron emission display.

According to one aspect of the present invention, an electron emission display is provided including cathode electron lines, gate electron lines, phosphor cells, and a positive plate. The cathode electrode lines are electrically connected to electron emission sources. Openings corresponding to the electron emission sources are formed in the gate electrode lines at portions where the gate electrode lines intersect the cathode electrode lines. The phosphor cells are formed to correspond to the openings in the gate electrode lines. A voltage is supplied to the positive plate N to move electrons emitted from the electron emission sources to the phosphor cells. Scanning pulses, whose voltages gradually rise, are sequentially supplied to the gate electrode lines in a unit frame, such that reference voltages of the gate electrode lines gradually rise in proportion to the relative distances between the gate electrode lines and driving terminals of the cathode electrode lines.

An average reference voltage of the gate electrode lines is preferably inversely proportional to an average gray-scale level of each frame.

A reference voltage of the cathode electrode lines is preferably constant.

Data pulses falling to a reference voltage of the cathode electrode lines from a bias voltage higher than the reference voltage of the cathode electrode lines are preferably supplied to the cathode electrode lines during a scanning pulse being supplied to one of the gate electrode lines.

A reference voltage of a gate electrode line nearest the driving terminals of the cathode electrode lines is preferably higher than the reference voltage of the cathode electrode lines.

A width of each of the data pulses preferably changes in proportion to a display gray-scale level.

A positive voltage higher than a maximum voltage of the scanning pulses is preferably supplied to the positive plate.

According to another aspect of the present invention, a method of driving an electron emission display is provided, the method comprising: electrically connecting cathode electrode lines to electron emission sources; arranging openings in gate electrode lines corresponding to the electron emission sources, the openings being arranged at intersections of the gate electrode lines and the cathode electrode lines; arranging phosphor cells to correspond to the openings of the gate electrode lines; and inputting a voltage to a positive plate to move electrons emitted from the electron emission sources to the phosphor cells in accordance with the received voltage; sequentially supplying scanning pulses, having gradually rising voltages, to the gate electrode lines in a unit frame, wherein reference voltages of the gate electrode lines gradually rise in proportion to relative distances between the gate electrode lines and driving terminals of the cathode electrode lines.

An average reference voltage of the gate electrode lines is preferably inversely proportional to an average gray-scale level of each frame.

A reference voltage of the cathode electrode lines is preferably constant.

The method preferably further includes supplying data pulses falling to a reference voltage of the cathode electrode lines from a bias voltage higher than the reference voltage of the cathode electrode lines to the cathode electrode lines during a scanning pulse being supplied to one of the gate electrode lines.

A reference voltage of a gate electrode line nearest the driving terminals of the cathode electrode lines is preferably higher than the reference voltage of the cathode electrode lines.

A width of each of the data pulses preferably changes in proportion to a display gray-scale level.

The method preferably further includes supplying a positive voltage higher than a maximum voltage of the scanning pulses to the positive plate.

By adjusting a reference voltage of the gate electrode lines, it is possible to efficiently compensate for brightness deviations due to the internal resistance of the cathode electrode lines. As a result, the reproducibility of images to be displayed is enhanced.

Preferably, an average reference voltage of the gate electrode lines in each frame is inversely proportional to an average gray-scale level of the each frame. Therefore, display quality in dark images as well as in bright images are efficiently improved.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a block diagram of an electron emission display according to an embodiment of the present invention;

FIG. 2 is a partially exploded perspective view of the electron emission display of FIG. 1;

FIG. 3 is a block diagram of voltages supplied from a power supplying unit of FIG. 1 to respective units;

FIG. 4 is a timing diagram of driving signals respectively supplied to gate electrode lines, a focusing electrode plate, and cathode electrode lines of FIG. 2, according to an embodiment of the present invention;

FIG. 5 is a block diagram of a controller of FIG. 1 for generating the driving signals shown in FIG. 4, according to an embodiment of the present invention;

FIG. 6 is a timing diagram of driving signals respectively supplied to the gate electrode lines, the focusing electrode plate, and the cathode electrode lines of FIG. 2, according to another embodiment of the present invention; and

FIG. 7 is a block diagram of a controller of FIG. 1 for generating the driving signals shown in FIG. 6, according to another embodiment of the present invention.

### DETAILED DESCRIPTION OF THE INVENTION

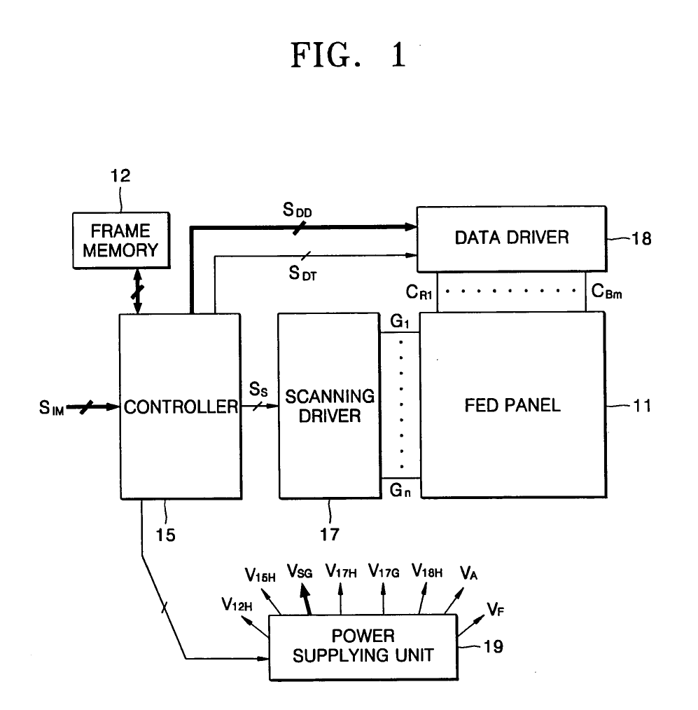

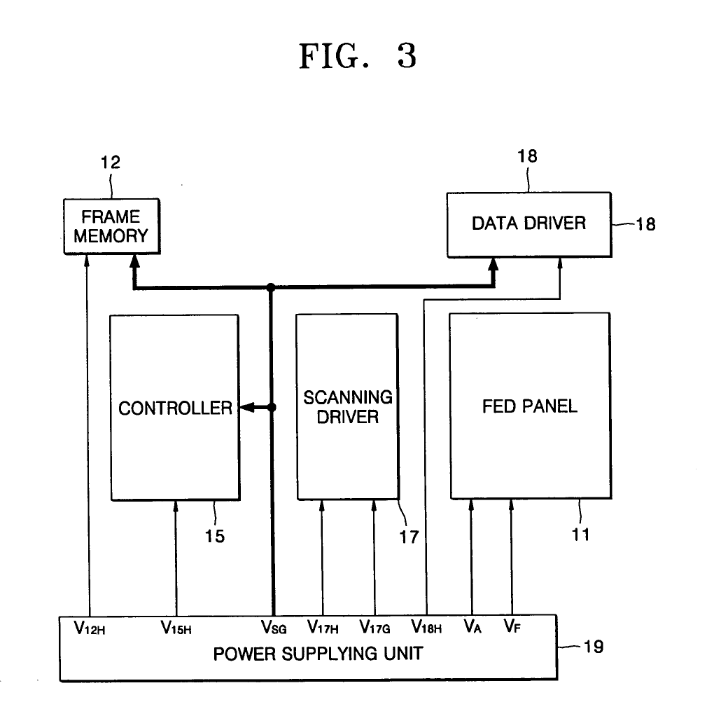

FIG. 1 is a block diagram of an electron emission display according to an embodiment of the present invention. FIG. 3 is a block diagram for explaining voltages which are supplied from a power supplying unit 19 of FIG. 1 to respective units.

Referring to FIGS. 1 and 3, the electron emission display includes an electron emission display panel 11 and a driving apparatus for driving the electron emission display panel 11. The driving apparatus includes a power supplying unit 19, a scanning driver 17, a data driver 18, a frame memory 12, and a controller 15.

The power supplying unit 19 supplies a system reference voltage VSG and an operating voltage V12H to the frame memory 12, supplies the system reference voltage VSG and an operating voltage V15H to the controller 15, supplies a variable reference voltage V17G and an operating voltage V17H to the scanning driver 17, supplies the system reference voltage VSG and an operating voltage V18H to the data driver 18, supplies a positive voltage VA to a positive plate 22 of the electron emission display panel 11, and supplies a focusing voltage VF to a focusing electrode plate 36 of the electron emission display panel 11.

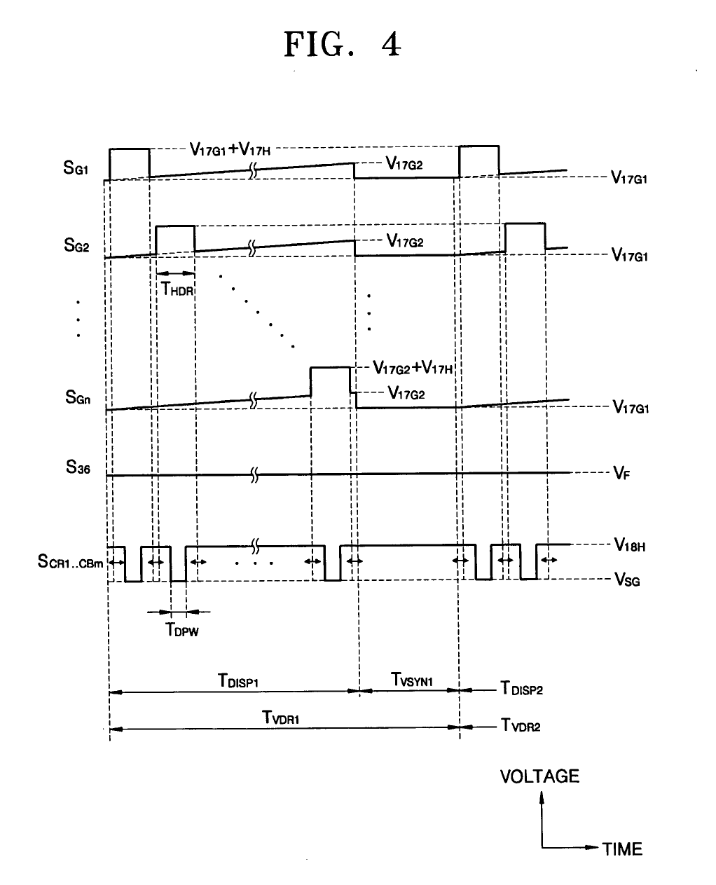

The power supplying unit 19 operates in response to control signals received from the controller 15, such that the power supplying unit 19 supplies, to the scanning driver 17, a variable reference voltage V17G gradually rising in proportion to the relative distances between the gate electrode lines G1, . . . , Gn and the driving terminals of the cathode electrode lines CR1, . . . , CBm, when scanning pulses are sequentially supplied to the gate electrodes G1, . . . , Gn in a unit frame. This operation is described in detail later with reference to FIGS. 4 through 7.

The scanning driver 17 drives the gate electrode lines G1, . . . , Gn which are used as scanning electrode lines of the electron emission display panel 11. The data driver 18 drives the cathode electrode lines CR1, . . . , CBm which are used as data electrode lines of the electron emission display panel 11. The frame memory 12 temporarily stores digital image data.

The controller 15, which may be an integrated circuit device, for example, a Field-Programmable Gate Array (FPGA), performs the following functions. First, the controller 15 converts input image signals SIM into digital image data, and temporarily stores the digital image data in the frame memory 12 and simultaneously generates pulse-width modulation data SDD and timing control signals SDT for a gray-scale display. Second, the controller 15 provides the pulse-width modulation data SDD and the timing control signals SDT to the data driver 18, and provides timing control signals SS to the scanning driver 17. Third, the controller 15 provides control signals to the power supplying unit 19. The power supplying unit 19 operates in response to the control signals received from the controller 15, such that the power supplying unit 19 supplies, to the scanning driver 17, a variable reference voltage V17G gradually rising in proportion to the relative distances between the gate electrode lines G1, . . . , Gn and the driving terminals of the cathode electrode lines CR1, . . . , CBm, when scanning pulses are sequentially supplied to the gate electrodes G1, . . . , Gn in a unit frame. This operation is described in detail later with reference to FIGS. 4 through 7.

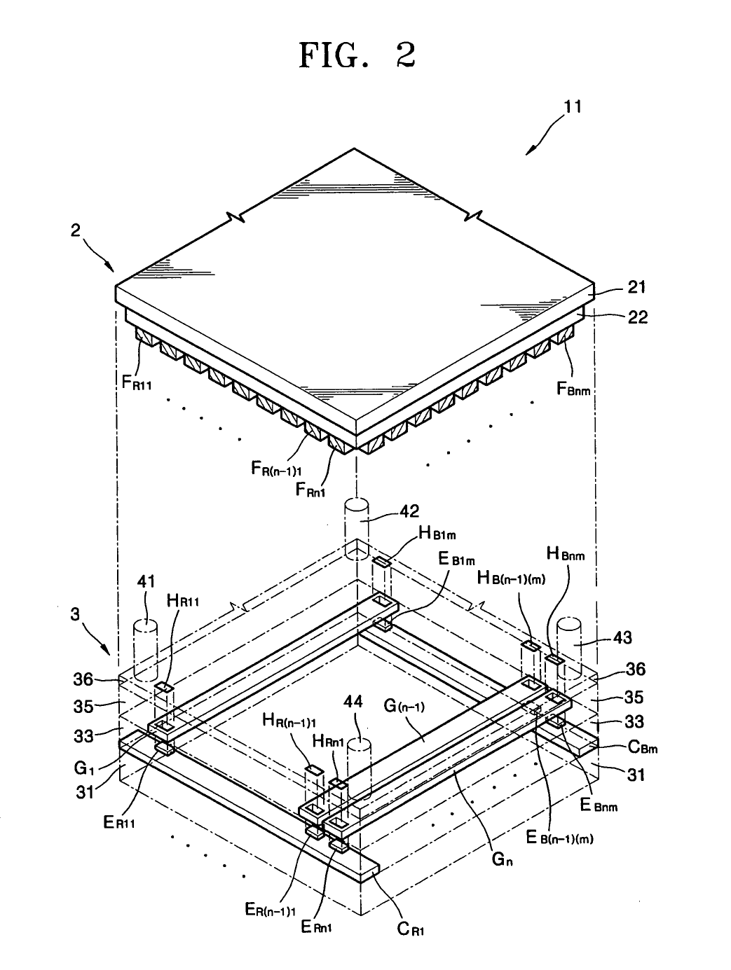

Referring to FIG. 2, in the electron emission display panel 11, a front panel 2 and a rear panel 3 are supported by space bars 41 through 44. Other than the space bars 41 through 44, a plurality of different space bars exist on the focusing electrode plate 36 of the electron emission display panel 11.

The rear panel 3 includes a rear substrate 31, cathode electrode lines CR1, . . . , CBm, electron emission sources ER11, . . . , EBnm, a first insulation layer 33, gate electrode lines G1, . . . , Gn, a second insulation layer 35, and a focusing electrode plate 36.

The cathode electrode lines CR1, . . . , CBm to which data signals are supplied are electrically connected to the electrode emission sources ER11, . . . , EBnm. Openings HR11, . . . , HBnm corresponding to the electron emission sources ER11, . . . , EBnm are formed to pass through the first insulation layer 33, the gate electrode lines G1, . . . , Gn, the second insulation layer 35, and the focusing electrode plate 36. A focusing voltage VF is supplied to the focusing electrode plate 36.

The front panel 2 includes a front transparent substrate 21, a positive plate 22, and phosphor cells FR11, . . . , FBnm. The phosphor cells FR11, . . . , FBnm are formed to correspond to the openings HR11, . . . , HBnm formed in the focusing electrode plate 36. A high positive voltage VA of 1 to 4 KV is supplied to the positive plate 22, to move electrons emitted from the electron emission sources ER11, . . . , EBnm to the phosphor cells FR11, . . . , FBnm.

FIG. 4 is a timing diagram of driving signals respectively supplied to the gate electrode lines G1, . . . , Gn, the focusing electrode plate 36, and the cathode electrode lines CR1, . . . , CBm, shown in FIG. 2, according to an embodiment of the present invention. In FIG. 4, SG1 represents a driving signal supplied to the first gate electrode line G1 of the gate electrode lines G1, . . . , Gn, SG2 represents a driving signal supplied to the second gate electrode line of the gate electrode lines G1, . . . , Gn, SGn represents a driving signal supplied to the n-th gate electrode line Gn of the gate electrode lines G1, . . . , Gn, S36 represents a driving signal supplied to the focusing electrode plate 36, and SCR1 . . . CBm represents driving signals supplied to the cathode electrode lines CR1, . . . , CBm.

Driving signals according to an embodiment of the present invention are described below with reference to FIGS. 2 through 4.

Referring to FIG. 4, a vertical driving period TVDR includes a vertical display period TDISP1 and a vertical synchronization period TVSYN. During the vertical driving period TVDR, a positive voltage higher than a maximum voltage of a scanning pulse is supplied to the positive plate 22. During the vertical display period TDISP1, positive scanning pulses with a pulse width THDR and variable positive voltages V17G1+V17H through V17G2+Vl7H, where a set positive voltage V17H is added to variable reference voltages V17G1 through V17G2, are sequentially supplied to the gate electrode lines G1, . . . , Gn. That is, by increasing reference voltages of the gate electrode lines G1, . . . , Gn in proportion to the relative distance between the gate electrode lines G1, . . . , Gn and the driving terminals of the cathode electrode lines CR1, . . . , CBm, different scanning pulses, whose voltages gradually rise, are sequentially supplied to the gate electrode lines G1, . . . , Gn.

As such, by adjusting the reference voltage of the gate electrode lines G1, . . . , Gn, it is possible to efficiently compensate for brightness deviations due to the internal resistance of the cathode electrode lines CR1, . . . , CBm. Accordingly, it is possible to enhance the reproducibility of images to be displayed.

While the scanning pulses are sequentially supplied to the gate electrode lines G1, . . . , Gn, data pulses falling to a predetermined reference voltage (i.e., a system reference voltage VSG) of the cathode electrode lines CR1, . . . , CBm from a driving voltage (i.e., a bias voltage V18H) higher than the reference voltage VSG, are supplied to the cathode electrode lines CR1, . . . , CBm.

The reference voltage V17G1 of the first gate line G1 nearest the driving terminals of driving the cathode electrode lines CR1, . . . , CBm is higher than the reference voltage VSG of the cathode electrode lines CR1, . . . , CBm. Accordingly, since the differences between the bias voltage V18H of the cathode electrode lines CR1, . . . , CBm and the variable reference voltages V17G1 and V17G2 of gate electrode lines G1, . . . , Gn to which no scanning pulse is supplied are reduced, contrast deterioration caused by abnormal discharges can be prevented.

The pulse widths TDPW of data signals supplied to the cathode electrode lines CR1, . . . , CBm change according to gray-scale levels. For example, the width TDPW of a negative data pulse of data with a maximum gray-scale level is equal to that of a corresponding positive scanning pulse THDR. Also, for data with a minimum gray-scale level, the width TDPW of a corresponding negative data pulse is zero, and a ground voltage of 0V is supplied. Accordingly, if certain cathode electrode lines CR1, . . . , CBm are continuously maintained at a minimum gray-scale level, a ground voltage of 0V is continuously maintained.

A positive voltage VF is supplied to the focusing electrode plate 36 to focus electrons emitted through the openings HR11, . . . , HBnm.

Then, during the vertical synchronization period TVSYN, the minimum reference voltage V17G1 is supplied to all of the gate electrode lines G1, . . . , Gn, the bias voltage V18H is supplied to all of the cathode electrode lines CR1, . . . , CBm, and the focusing voltage VF is supplied to the focusing electrode plate 36.

As described above, a positive voltage higher than the maximum voltage V17G2+V17H of the scanning pulse is supplied to the positive plate 22.

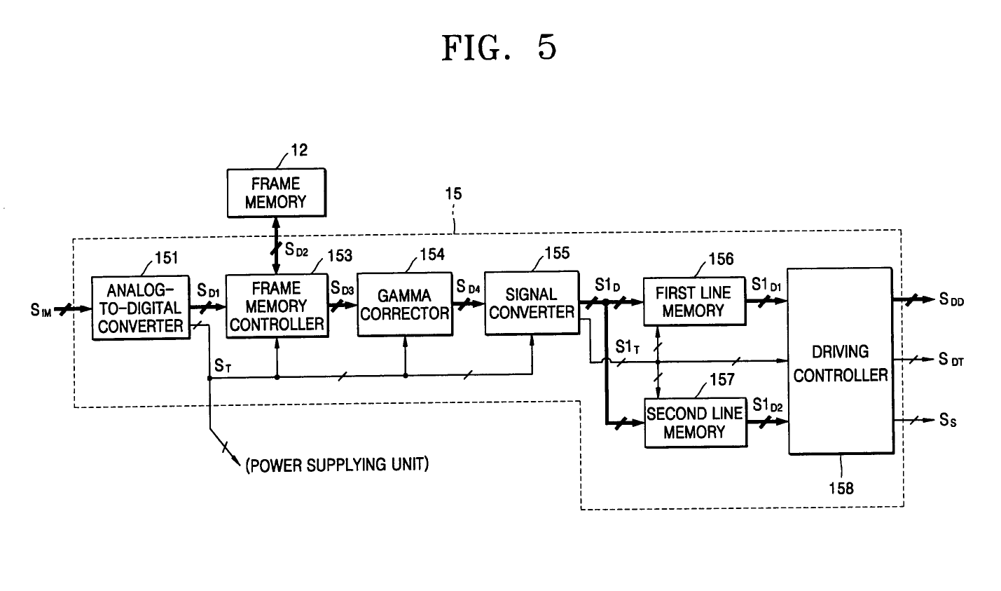

Referring to FIGS. 1 and 5, the controller 15 for generating the driving signals shown in FIG. 4 includes an analog-to-digital converter 151, a frame memory controller 153, a gamma corrector 154, a signal converter 155, a first line memory 156, a second line memory 157, and a driving controller 158.

The analog-to-digital converter 151 converts input image signals SIM into digital image data SD1 and timing control signals ST. The timing control signals ST output from the analog-to-digital converter 151 are respectively supplied to the power supplying unit 19, the frame memory controller 153, the gamma corrector 154, and the signal converter 155.

As described above, the power supplying unit 19 operates in response to the timing control signals ST received from the analog-to-digital converter 151 of the controller 15, such that the power supplying unit 19 supplies, to the scanning driver 17, the variable reference voltages V17G gradually rising in proportion to the relative distances between the gate electrode lines G1, . . . , Gn and the driving terminals of the cathode electrode lines CR1, . . . , CBm, when scanning pulses are sequentially supplied to the gate electrodes G1, . . . , Gn in a unit frame.

The frame memory controller 153 operates in response to the timing control signals ST received from the analog-to-digital converter 151, such that the frame memory controller 153 temporarily stores digital image data SD2 received from the analog-to-digital converter 151 in the frame memory 12 and then outputs digital image data SD3 received from the frame memory 12.

The gamma corrector 154 corrects the gamma characteristics of the digital image data SD3 received from the frame memory controller 153, in response to the timing control signals ST received from the analog-to-digital converter 151. Each of the input image signals SIM includes gamma characteristics to compensate for the inverse-gamma display characteristics of cathode ray tubes.

Accordingly, in order to drive the electron emission display panel 11 with linear display characteristics, the inverse gamma characteristic must be included in the input image signals SIM.

The signal converter 155 converts digital image data SD4 received from the gamma corrector 154 into pulse-width modulation data S1D and generates adjusted timing control singles S1T, in response to the timing control signals ST received from the analog-to-digital converter 151.

The first and second line memories 156 and 157 alternately output the pulse-width modulation data S1D received from the signal converter 155 to the respective scanning lines.

The driving controller 158 receives pulse-width modulation data S1D1 and S1D2 from the first and second line memories 156 and 157, provides pulse-width modulation data SDD and timing control signals SDT to the data driver 18, and provides timing control signal SS to the scanning driver 17, in response to the timing control signals S1T received from the signal converter 155.

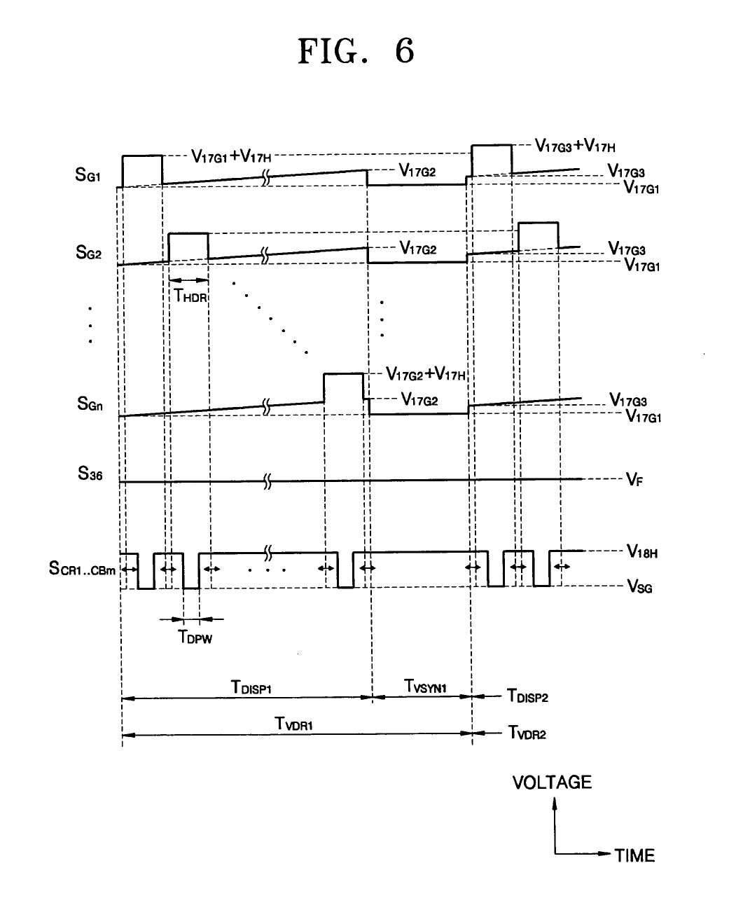

FIG. 6 is a timing diagram of driving signals respectively supplied to the gate electrode lines G1, . . . , Gn, the focusing electrode plate 36, and the cathode electrode lines CR1, . . . , CBm, shown in FIG. 2, according to another embodiment of the present invention. In FIG. 6, components having the same reference numbers as those of FIG. 4 operate in the same manner as the respective components of FIG. 4. Therefore, only differences between the driving signals shown FIG. 6 and those shown in FIG. 4 are described below.

In the embodiment of FIG. 4, driving waveforms supplied to the gate electrode lines G1, . . . , Gn during the first vertical display period TDISP1 are the same as those supplied to the gate electrode lines G1, . . . , Gn during the second vertical display period TDISP2.

However, in the embodiment of FIG. 6, an average reference voltage supplied in each frame, that is, in each vertical display period TDISP1, TDISP2, . . . is inversely proportional to an average gray-scale level of the each vertical display period TDISP1, TDISP2, . . . . For example, if an average gray-scale level of the second vertical display period TDISP2 is lower than that of the first vertical display period TDISP1, as shown in FIG. 6, a variable reference voltage supplied in the second vertical display period TDISP2 is higher than that supplied in the first vertical display period TDISP1. Referring to FIG. 6, for the first gate electrode line G1 nearest the driving terminals of driving the cathode electrode lines CR1, . . . , CBm, a voltage V17G3 supplied to the first gate electrode line G1 in the second vertical display period TDISP2 is higher than a voltage V17G1 supplied to the first gate electrode line G1 in the first vertical display period TDISP1.

Therefore, display quality in dark images as well as in bright images can be efficiently improved.

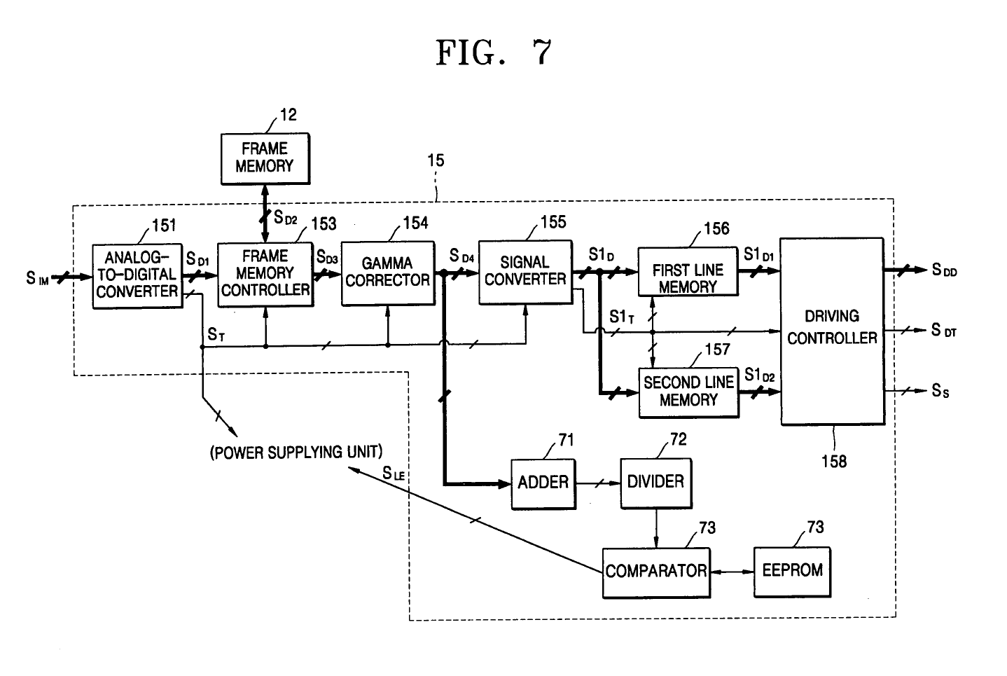

FIG. 7 is a block diagram of the controller 15 of FIG. 1 for generating the driving signals shown in FIG. 6, according to another embodiment of the present invention. In FIG. 7, components having the same reference numbers as those of FIG. 5 operate in the same manner as the respective components of FIG. 5. Referring to FIGS. 5 and 7, the controller shown in FIG. 7 further includes an adder 71, a divider 72, a comparator 73, and an Electrically Erasable and Programmable Read Only Memory (EEPROM) 74, differently from the controller shown in FIG. 5. Also, a control signal SLE output from the comparator 73, that is, data SLE with an average reference voltage is input to the power supplying unit (19 of FIG. 1).

Hereinafter, the differences between the controller shown in FIG. 7 and the controller shown in FIG. 5 are described.

The adder 71 receives digital image data SD4 from the gamma corrector 154 and obtains a total gray-scale level which is a sum of gray-scale levels of all pixels in a current frame.

The divider 72 divides the total gray-scale level received from the adder 71 by the total number of the pixels, thus obtaining an average gray-scale level of the current frame. The EEPROM 74 stores reference data corresponding to average gray-scale levels of frames.

Then, the comparator 73 compares the average gray-scale level of the current frame received from the divider 72 with corresponding reference data, thus generating data SLE corresponding to an average reference voltage of the current frame. The generated data SLE is input to the power supplying unit (19 of FIG. 1).

As described above, the power supplying unit 19 operates in response to the timing control signals ST received from the analog-to-digital converter 151, such that the power supplying unit 19 supplies, to the scanning driver 17, a variable reference voltage V17G gradually rising in proportion to the relative distances between the gate electrode lines G1, . . . , Gn and the driving terminals of driving the cathode electrode lines CR1, . . . , CBm, when scanning pulses are sequentially supplied to the gate electrodes G1, . . . , Gn in a unit frame. Also, the power supplying unit 19 outputs an average reference voltage of the scanning driver 17 to be supplied in each frame, that is, in each vertical display period TDISP1, TDISP2, . . . according to the data SLE received from the comparator 73, wherein the average reference voltage is inversely proportional to the average gray-scale level of the each vertical display period TDISP1, TDISP2, . . . .

As described above, according to an electron emission display of the present invention, by adjusting a reference voltage of gate electrode lines, it is possible to efficiently compensate for brightness deviations due to the internal resistance of cathode electrode lines. Accordingly, it is as possible to enhance the reproducibility of images to be displayed.

An average reference voltage of gate electrode lines in each frame is inversely proportional to an average gray-scale level in the each frame. Therefore, display quality in dark images as well as in bright images can be efficiently improved.

While the present invention has been particularly shown and described with reference to exemplary embodiments thereof, it will be understood by those of ordinary skill in the art that various modifications in form and detail can be made therein without departing from the spirit and scope of the present invention as defined by the following claims.

What is claimed is:

1. An electron emission display comprising:
cathode electrode lines electrically connected to electron emission sources;
gate electrode lines including openings corresponding to the electron emission sources, the openings being arranged at intersections of the gate electrode lines and the cathode electrode lines;
phosphor cells arranged to correspond to the openings of the gate electrode lines; and
a positive plate adapted to receive a voltage and to move electrons emitted from the electron emission sources to the phosphor cells in accordance with the received voltage;
wherein scanning pulses, having gradually rising voltages, are sequentially supplied to the gate electrode lines in a unit frame, such that reference voltages of the gate electrode lines gradually rise in proportion to relative distances between the gate electrode lines and driving terminals of the cathode electrode lines.

2. The electron emission display of claim 1, wherein an average reference voltage of the gate electrode lines is inversely proportional to an average gray-scale level of each frame.

3. The electron emission display of claim 1, wherein a reference voltage of the cathode electrode lines is constant.

4. The electron emission display of claim 2, wherein data pulses falling to a reference voltage of the cathode electrode lines from a bias voltage higher than the reference voltage of the cathode electrode lines are supplied to the cathode electrode lines during a scanning pulse being supplied to one of the gate electrode lines.

5. The electron emission display of claim 4, wherein a reference voltage of a gate electrode line nearest the driving terminals of the cathode electrode lines is higher than the reference voltage of the cathode electrode lines.

6. The electron emission display of claim 4, wherein a width of each of the data pulses changes in proportion to a display gray-scale level.

7. The electron emission display of claim 1, wherein a positive voltage higher than a maximum voltage of the scanning pulses is supplied to the positive plate.

8. A method of driving an electron emission display, the method comprising:
electrically connecting cathode electrode lines to electron emission sources;
arranging openings in gate electrode lines corresponding to the electron emission sources, the openings being arranged at intersections of the gate electrode lines and the cathode electrode lines;
arranging phosphor cells to correspond to the openings of the gate electrode lines; and
inputting a voltage to a positive plate to move electrons emitted from the electron emission sources to the phosphor cells in accordance with the received voltage;
sequentially supplying scanning pulses, having gradually rising voltages, to the gate electrode lines in a unit frame, wherein reference voltages of the gate electrode lines gradually rise in proportion to relative distances between the gate electrode lines and driving terminals of the cathode electrode lines.

9. The method of claim 8, wherein an average reference voltage of the gate electrode lines is inversely proportional to an average gray-scale level of each frame.

10. The method of claim 8, wherein a reference voltage of the cathode electrode lines is constant.

11. The method of claim 9, further comprising supplying data pulses falling to a reference voltage of the cathode electrode lines from a bias voltage higher than the reference voltage of the cathode electrode lines to the cathode electrode lines during a scanning pulse being supplied to one of the gate electrode lines.

12. The method of claim 11, wherein a reference voltage of a gate electrode line nearest the driving terminals of the cathode electrode lines is higher than the reference voltage of the cathode electrode lines.

13. The electron emission display of claim 11, wherein a width of each of the data pulses changes in proportion to a display gray-scale level.

14. The method of claim 8, further comprising supplying a positive voltage higher than a maximum voltage of the scanning pulses to the positive plate.
